(19) United States
(12) Patent Application Publication
(10) Pub. No.: US 2011/0310517 A1
(43) Pub. Date: Dec. 22, 2011

(54) OVERVOLTAGE PROTECTION MAGAZINE OR PLUG AND METHOD FOR PRODUCING AN OVERVOLTAGE PROTECTION MAGAZINE OR PLUG

(75) Inventor: Heiko Neumetzler, Berlin (DE)

(73) Assignee: ADC GmbH, Berlin (DE)

(21) Appl. No.: 13/203,430

(22) PCT Filed: Dec. 18, 2009
(86) PCT No.: PCT/EP09/09163

§ 371 Date: Aug. 25, 2011

(30) Foreign Application Priority Data
Feb. 27, 2009 (DE) 10 2009 010 929.3

(51) Int. Cl. H02H 9/04

(52) U.S. Cl. 361/56

(57) ABSTRACT

The invention relates to an overvoltage protection magazine (1) or plug, comprising a housing, at least one surge arrester (35), line contacts (10a), at least one grounding contact (21) and a mount (30) for the surge arresters (35), the mount (30) being in the form of a plastic injection-molded part, the line contacts (10a) and the at least one grounding contact (21) being partially injected into the plastic injection-molded part, and to a method for the production of an overvoltage protection magazine (1) or plug.

The invention relates to an overvoltage protection magazine or plug and to a method for the production of an overvoltage protection magazine or plug.

DE 10 2007 006 693 A1 has disclosed an overvoltage protection magazine, comprising a plastic housing, electrical contacts, overvoltage protection elements and at least one contact comb, the electrical contacts being arranged in the plastic housing and having in each case one plug-in region and one contact region, the electrical contacts in the plug-in region being arranged in a row, the plastic housing having receptacles for the overvoltage protection elements, which are arranged on both sides along the longitudinal direction, the contact regions of the electrical contacts protruding into the respective receptacle and producing a first electrical contact with the respective overvoltage protection element, and the contact comb having sprung contact elements in the region of the receptacles, which produce the second contact with the overvoltage protection element. The overvoltage protection elements are in this case in the form of two-pole surge arresters. The contacts are preferably in the form of contact gratings and are injection-molded into the plastic housing, which contact gratings are stamped free through openings in the plastic housing, whereas the contact comb is formed with grounding contacts and forms the connection to ground.

Furthermore, overvoltage protection magazines are known which comprise a printed circuit board, on which the overvoltage protection elements are arranged. The plug-in contacts are in this case in the form of cutouts in the printed circuit board, on which contact pads are arranged. One disadvantage of these overvoltage protection magazines is the relatively high cost of them since stringent demands in terms of quality are placed on the printed circuit board and the contact pads as a result of the high plug-in rate required.

The invention is based on the technical problem of providing an overvoltage protection magazine or plug and a method for the production of an overvoltage protection magazine or plug which is compact and inexpensive in terms of construction.

The solution to the technical problem results from the subject matters having the features of patent claims 1 and 15. Further advantageous configurations of the invention result from the dependent claims.

In this regard, the overvoltage protection magazine or plug comprises a housing, at least one surge arrester, line contacts, at least one grounding contact and a mount for the surge arresters, the mount being in the form of a plastic injection-molded part, the line contacts and the at least one grounding contact being partially injected into the plastic injection-molded part. This results in a very compact and inexpensive design of the mount. In this case it is conceivable to injection-mold the line contacts or the grounding contact as individual contacts.

In a preferred embodiment, however, the line contacts are in the form of at least one contact grating, which is stamped free by openings in the mount. The advantage of a contact grating is the fact that only a part needs to be aligned in the injection mold.

In a further preferred embodiment, the line contacts each have a plug-in region and a contact region, the plug-in regions not being encapsulated by injection molding.

In a further preferred embodiment, the plug-in regions are arranged in a row, and the contact regions and the plug-in regions lie in one plane.

In a further preferred embodiment, the line contacts in the contact grating are connected via a common transverse web, the plug-in regions being arranged below the transverse web, and the contact regions being arranged above the transverse web, in pairs one contact region being connected to the transverse web by a straight connecting web and the other contact region being connected to the transverse web via a connecting web which is bent back at two points, the first bend in the region of the transverse web guiding the connecting web into a parallel plane with respect to the plane of the contact regions, and the second bend in the region of the contact regions guiding back the connecting web into the plane of the contact regions, the connecting webs which are bent back at two points being longer than the straight connecting webs.

In a further preferred embodiment, the overvoltage protection magazine has two grounding contacts, which are connected to one another via a transverse web, the transverse web running between the contact regions of the line contacts without coming into touching contact with the connecting webs thereof. This is possible in a particularly simple manner in particular since the longer connecting webs run in a parallel plane which is set back, with the result that the grounding contacts can lie in the same plane, or virtually the same plane, as the contact regions or plug-in regions of the line contacts.

In a further preferred embodiment, the contact regions are in the form of rectangular contact strips, in pairs associated contact strips being arranged so as to be aligned one above the other.

In a further preferred embodiment, the mount has depressions, the contact regions being arranged in the base region of the depression. As a result, the surge arresters are held in position better and at the same time the contact grating or the grounding contacts is/are stabilized by the plastic.

In a further preferred embodiment, plastic is injected between the contact regions in the depression, which in particular serves the purpose of stabilizing the long connecting webs which are bent back at two points.

In a further preferred embodiment, the lower side of the mount has a notch between two plug-in regions of the line contacts, as a result of which the dielectric strength can be increased.

In a further preferred embodiment, the housing has intermediate walls, between which the surge arresters are arranged. This prevents a surge arrester which is released from disrupting the adjacent surge arrester and in particular causing short circuits.

In a further preferred embodiment, the rear side of the mount forms a housing wall.

In a further preferred embodiment, the surge arresters are in the form of SMD components.

In a further preferred embodiment, the surge arresters are in the form of three-pole surge arresters, with the result that in each case one surge arrester is required per twin core.

The invention will be explained in more detail below with reference to a preferred exemplary embodiment. In the figures:

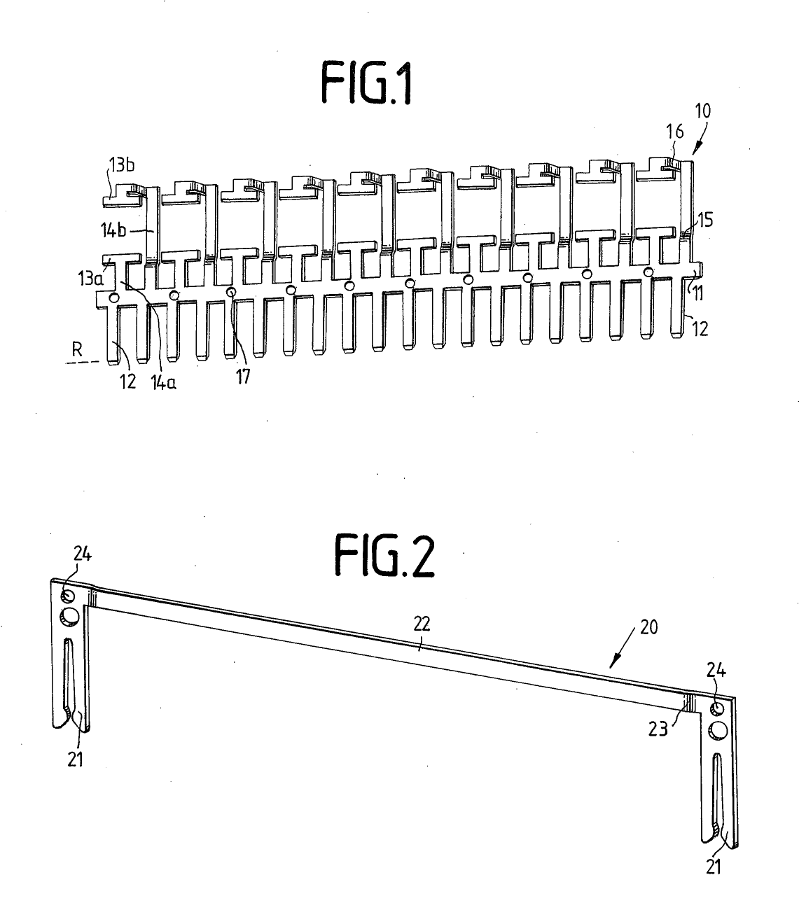

FIG. 1 shows a perspective illustration of a contact grating,

FIG. 2 shows a perspective illustration of grounding contacts,

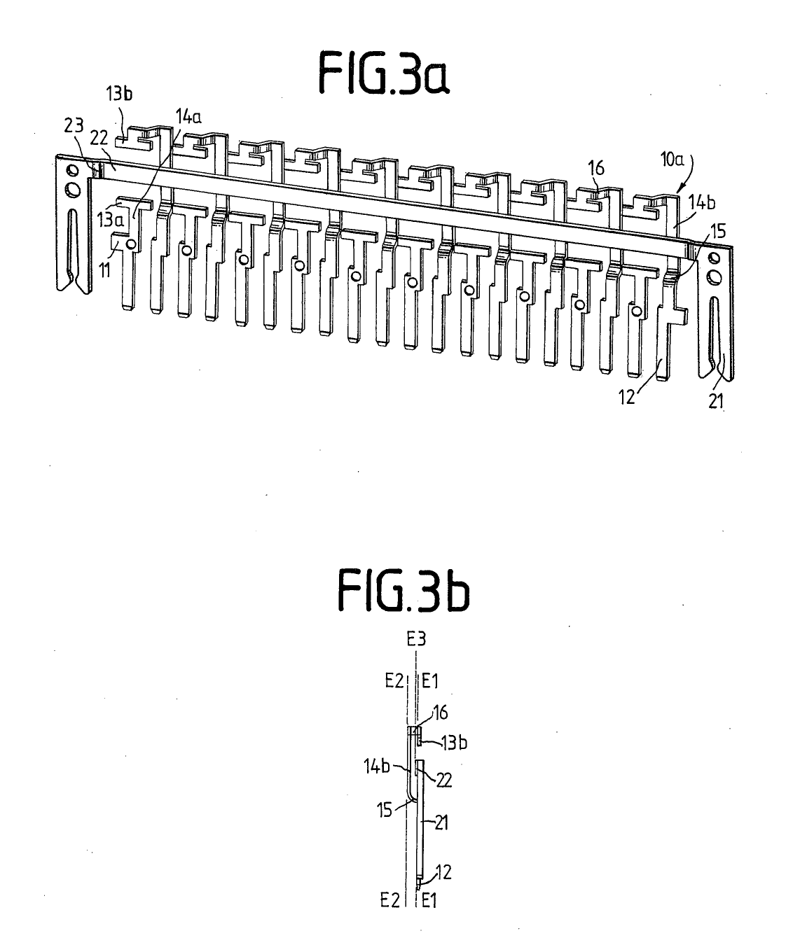

FIG. 3a shows a perspective illustration of contact gratings and grounding contacts prior to encapsulation by injection molding with plastic,

FIG. 3b shows a side view of the arrangement shown in FIG. 3a,

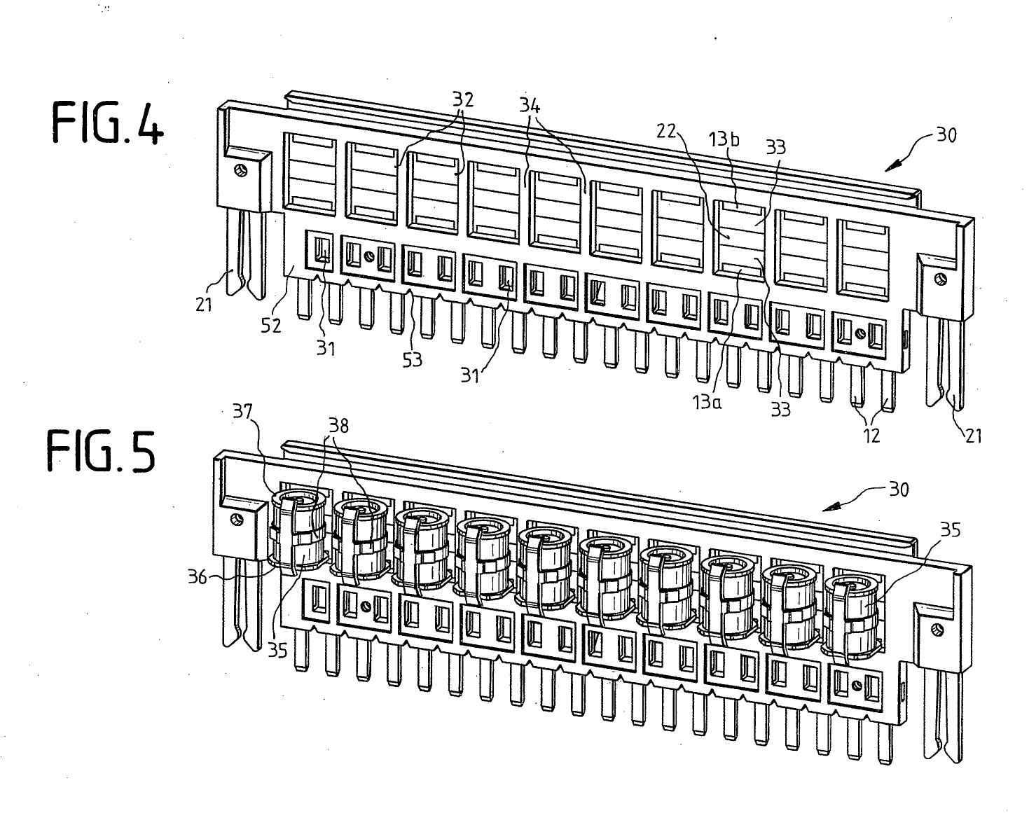

FIG. 4 shows a perspective front view of a mount without a surge arrester,

FIG. 5 shows a perspective front view of the mount with surge arresters,

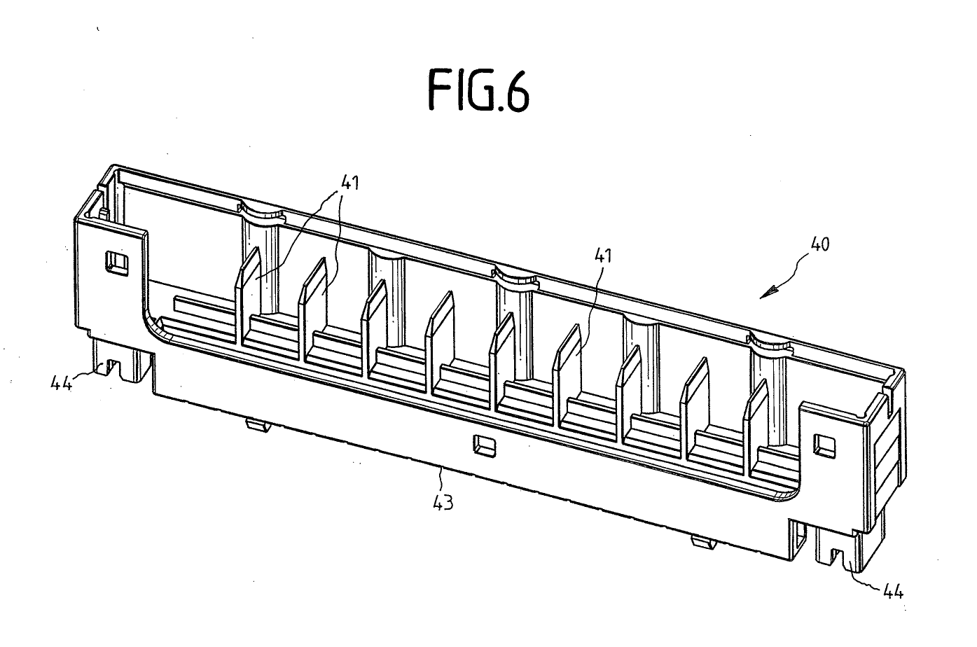

FIG. 6 shows a perspective rear view of a housing,

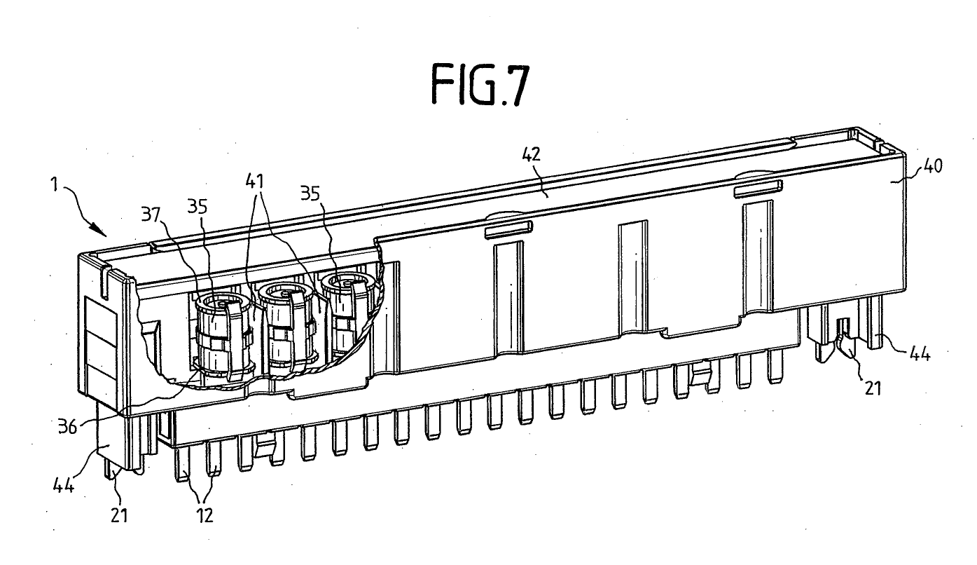

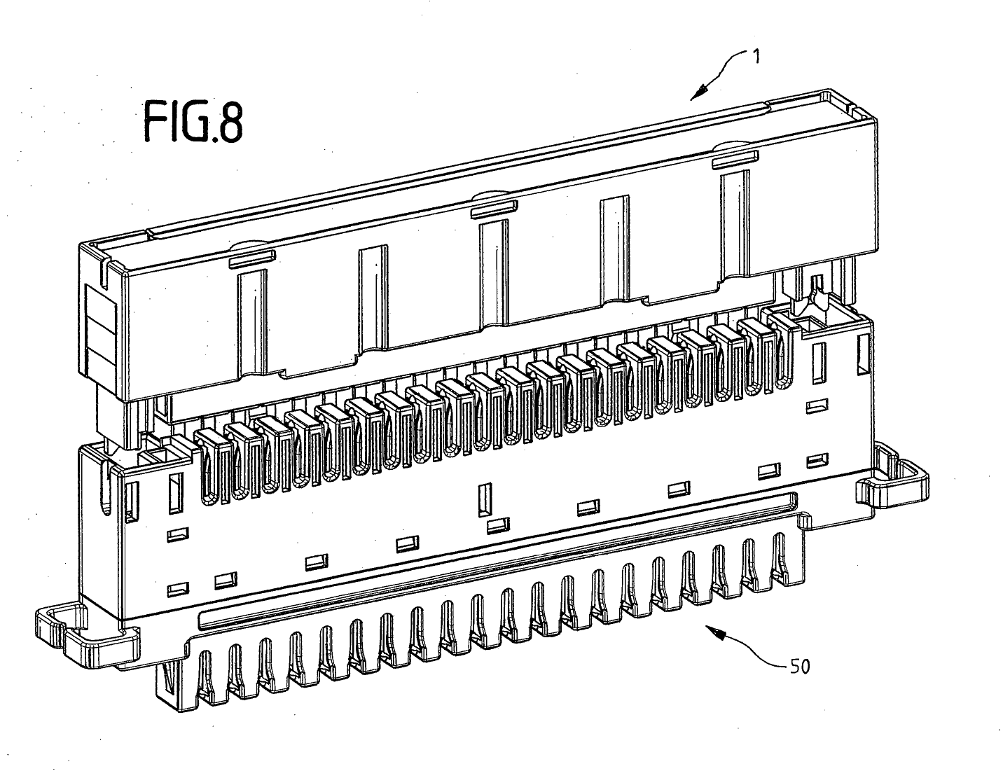

FIG. 7 shows a perspective front view of an assembled overvoltage protection magazine,

FIG. 8 shows a perspective front view of the overvoltage protection magazine with a terminal block, and

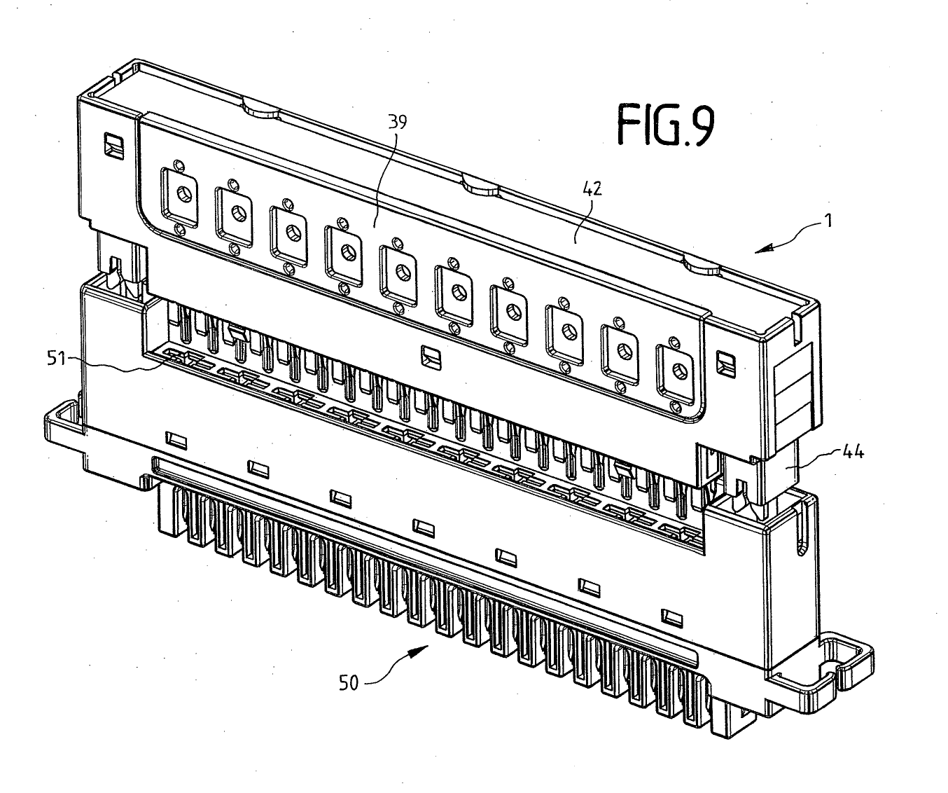

FIG. 9 shows a perspective rear view of the overvoltage protection magazine with the terminal block.

FIG. 1 illustrates a contact grating 10 for twenty line contacts 10a (see FIG. 3a) for a 10 twin core overvoltage protection magazine, the twenty line contacts 10a first of all being connected to one another via a common transverse web 11. Twenty plug-in regions 12 of the line contacts 10a, which are all arranged in a row R, are therefore arranged below the transverse web 11. The plug-in regions 12 are then plugged into interfaces 51 of a terminal block 50 (FIG. 9), which are in the form of isolating contacts or fork contacts, for example. Contact regions 13a, 13b which are used for making contact with surge arresters 35 (FIG. 5) are arranged above the transverse web 11. Ten contact regions 13a and ten corresponding contact regions 13b are therefore provided for the ten surge arresters 35. The contact regions 13a are connected to the transverse web 11 via a short, straight connecting web 14a. The contact regions 13b are connected to the transverse web 11 via a connecting web 14b, which is bent back at two points. The plug-in regions 12 and the contact regions 13a, 13b in this case lie in one plane E1 (see FIG. 3b). The first bend 15 in the region of the transverse web 11 guides the connecting web 14b into a parallel plane E2 (FIG. 3b) with respect to the plane E1 of the contact regions 13a, 13b. The second bend 16 guides the connecting web 14b back into the plane E1 of the contact regions 13a, 13b again and at the same time shifts the contact region 13b slightly to the left, with the result that the contact regions 13a, 13b are arranged flush with respect to one another. Furthermore, the transverse web 11 is formed with holes 17, into which holding pins of an injection-molding die can be inserted in order to hold the contact grating 10 in a defined manner in the injection-molding die. In the exemplary embodiment, the distance between two adjacent holes 17 on the transverse web 11 corresponds to approximately twice the distance between two adjacent plug-in regions 12.

FIG. 2 illustrates a grounding rail 20. The grounding rail 20 comprises two grounding contacts 21, which are in the form of fork contacts. The two grounding contacts 21 are connected to one another via a transverse web 22, the transverse web 22 having in each case one bend 23 in the region of the grounding contacts 21, with the result that the grounding contacts 21 and the transverse web 22 lie in different planes, although these planes are parallel. In the upper region, the grounding contacts 21 have holes 24, which are again used for holding purposes within the injection mold.

FIG. 3a finally shows the contact grating 10 and the grounding rail 20, showing the way in which they would be arranged together in an injection-molding die. In this case, the transverse web 22 of the grounding rail 20 lies in a plane E3 (see FIG. 3b) between the plane E1 of the contact regions 13a, 13b and the plane E2 of the connecting webs 14b, with the result that the transverse web 22 does not come into touching contact with the connecting webs 14b. In this case, the transverse web 11 has been stamped free in each case between two connecting webs 14a, 14b, but this stamping-free operation does not take place until after the injection-molding operation. As a result of the stamping-free operation, ten separate plug-in regions 12 with the contact regions 13a and ten separate plug-in regions 12 with the contact regions 13b are thus formed.

FIG. 4 illustrates a mount 30, into which the contact grating 10 and the grounding rail 20 are partially injection-molded, the plug-in regions 12 and the two grounding contacts 21 not being encapsulated by injection molding. The mount is slightly broader above the grounding contacts 21 in order to increase stability. Furthermore, stamped-free openings 31 are shown through which the contact grating 10 is stamped free, as illustrated in FIG. 3. The mount 30 also has depressions 32, the contact regions 13b, 13a and in each case one part of the transverse web 22 of the grounding rail 20 being superficially exposed in the bottom region. Plastic strips 33, which stabilize the connecting webs 14b (see FIG. 1), are injection-molded between the contact regions 13a, 13b and the grounding rail 20. The thick plastic webs 34 which are formed between the depressions 32, on the other hand, additionally stabilize the grounding rail 20 (see FIG. 2). The lower side 52 of the mount 30 with notches 53 is formed between in each case two plug-in regions 12 in order to increase the dielectric strength.

FIG. 5 illustrates the mount 30 fitted with three-pole surge arresters 35, which are arranged in the respective depressions 32. In this case, the two outer poles 36, 37 of the surge arresters 35 are connected to the contact regions 13a, 13b and the central ground contact 38 is connected to the transverse web 22. The connection can in this case be realized, for example, by means of soldering, laser-welding or adhesive bonding.

FIG. 6 illustrates a housing 40 for an overvoltage protection magazine for accommodating the mount 30. The housing 40 has intermediate walls 41, between which the individual surge arresters 35 are arranged if the mount 30 is inserted into the housing 40. In this case, the rear side 39 of the mount 30 virtually completely forms a side wall of the housing 40, as can be seen in FIG. 9. The housing 40 is closed off on the upper side by a covering strip 42 (see FIG. 7). The housing 40 has two domes 44 on the lower side 43, through which domes the grounding contacts 21 are guided, the overvoltage protection magazine 1 (see FIGS. 8 and 9) latching in a terminal block 50 by means of the domes 44. The completely assembled overvoltage protection magazine 1 is illustrated in FIG. 7, with part of the side wall which is opposite the mount 30 being broken away, with the result that the position of the surge arresters 35 between the intermediate walls 41 can be seen. The action of the overvoltage protection magazine 1 being plugged into the terminal block 50 is illustrated in FIGS. 8 and 9. FIG. 9 shows the interfaces 51 of the terminal block 50 for accommodating the plug-in regions 12.

### LIST OF REFERENCE SYMBOLS

1 Overvoltage protection magazine
10 Contact grating
10a Line contact
11 Transverse web
12 Plug-in regions
13a, 13b Contact regions
14a, 14b Connecting webs
15 First bend
16 Second bend
17 Holes
20 Grounding rail
21 Grounding contacts
22 Transverse web
23 Bend
24 Holes
30 Mount
31 Stamped-free openings
32 Depressions
33 Plastic strips
34 Plastic webs
35 Surge arresters
36, 37 Poles
38 Ground contact
39 Rear side
40 Housing
41 Intermediate walls
42 Covering strips
43 Lower side
44 Domes
50 Terminal block
51 Interfaces
52 Lower side
53 Notch
E1-E3 Plane

1. An overvoltage protection magazine or plug, comprising a housing, at least one surge arrester, line contacts, at least one grounding contact and a mount for the surge arresters, wherein the mount is in the form of a plastic injection-molded part, the line contacts and the at least one grounding contact being partially injected into the plastic injection-molded part.

2. The overvoltage protection magazine as claimed in claim 1, wherein the line contacts are in the form of at least one contact grating, which is stamped free by openings in the mount.

3. The overvoltage protection magazine as claimed in claim 1, wherein the line contacts each have a plug-in region and a contact region, the plug-in regions not being encapsulated by injection molding.

4. The overvoltage protection magazine as claimed in claim 3, wherein the plug-in regions are arranged in a row, and the contact regions and the plug-in regions lie in one plane.

5. The overvoltage protection magazine as claimed in claim 4, wherein the line contacts in the contact grating are connected via a common transverse web, the plug-in regions being arranged below the transverse web, and the contact regions being arranged above the transverse web, in pairs one contact region being connected to the transverse web by a straight connecting web and the other contact region being connected to the transverse web via a connecting web which is bent back at two points, the first bend in the region of the transverse web guiding the connecting web into a parallel plane with respect to the plane of the contact regions, and the second bend in the region of the contact regions guiding back the connecting web into the plane of the contact regions, the connecting webs which are bent back at two points being longer than the straight connecting webs.

6. The overvoltage protection magazine as claimed in claim 5, wherein the overvoltage protection magazine has two grounding contacts, which are connected to one another via a transverse web, the transverse web running between the contact regions of the line contacts without coming into touching contact with the connecting webs thereof.

7. The overvoltage protection magazine as claimed in claim 3, wherein the contact regions are in the form of rectangular contact strips, in pairs associated contact strips being arranged so as to be aligned one above the other.

8. The overvoltage protection magazine as claimed in claim 6, wherein the mount has depressions, the contact regions being arranged in the base region of the depression.

9. The overvoltage protection magazine as claimed in claim 8, wherein plastic is injected between the contact regions in the depression.

10. The overvoltage protection magazine as claimed in claim 1, wherein the lower side of the mount has a notch between two plug-in regions of the line contacts.

11. The overvoltage protection magazine as claimed in, claim 1 wherein the housing has intermediate walls, between which the surge arresters are arranged.

12. The overvoltage protection magazine as claimed in claim 1, wherein the rear side of the mount forms a housing wall.

13. The overvoltage protection magazine as claimed in claim 1, wherein the surge arresters are in the form of SMD components.

14. The overvoltage protection magazine as claimed in claim 1, wherein the surge arresters are in the form of three-pole surge arresters.

15. A method for the production of an overvoltage protection magazine or plug as claimed in claim 1, wherein the line contacts and the at least one grounding contact are injected into the mount, which is in the form of a plastic injection-molded part, and the mount is inserted into the housing.
